(19) United States
(12) Patent Application Publication
(10) Pub. No.: US 2021/0148101 A1
(43) Pub. Date: May 20, 2021

(54) SINGLE HAND OPERATED FAUCET

(71) Applicant: Mordechai Lev, Bloomfield Hills, MI (US)

(72) Inventor: Mordechai Lev, Bloomfield Hills, MI (US)

(21) Appl. No.: 16/951,506

(22) Filed: Nov. 18, 2020

Related U.S. Application Data
(60) Provisional application No. 63/018,665, filed on May 1, 2020.
(60) Provisional application No. 62/936,869, filed on Nov. 18, 2019.

(51) Int. Cl. E03C 1/04; F16K 11/078

(52) U.S. Cl. CPC E03C 1/0412; E03C 1/0404; E03C 2001/0415; E03C 1/0405; F16K 11/0787

(57) ABSTRACT

A faucet for coupling to a pressurized fluid supply that including a hollow faucet body, a faucet head, a disc valve positioned within the head, and a valve control device. The faucet body having a base at a first end and a second end in fluid communication with the first end. The faucet head having a first end and an outlet at a second end, the first end of the head being removably attached to the second end of the faucet body. The disc valve that is positioned within the faucet head being configured to induce fluid flow and control a temperature of the fluid flow from the pressurized fluid supply through the outlet of the faucet head. The valve control device being positioned on an exterior surface of the faucet head and is mechanically connected to the disc valve and configured to actuate the disc valve.

### CROSS-REFERENCE TO RELATED APPLICATION

This application claims priority of U.S. Provisional Patent Application Ser. No. 62/936,869 filed Nov. 18, 2019 and U.S. Provisional Patent Application Ser. No. 63/018,665 filed May 1, 2020, which are incorporated herein by reference.

### FIELD OF THE INVENTION

The present invention in general relates to fluid flow control devices and in particular, to a faucet that may be controlled with single hand operation.

### BACKGROUND OF THE INVENTION

Conventional faucets contain a body, a water outlet, and at least one handle located on the body of the faucet to control water flow and temperature. The placement of the control handle on the body of conventional faucets results in bulky and limited faucet design, dimension, and aesthetic appearance, limiting the flexibility and attractiveness of the design or application. Such faucets are also difficult to clean resulting in the accumulation of grime, bacteria, or other contaminants on the faucet, leading to hygiene or other concerns.

Some conventional faucets also include a separable water head attached to an extendable water hose that allows a user to extend the water outlet on the water head from the body of the faucet. Such faucets require at least two hands to operate given the two separate locations of the water head when separated from the body and the handle. When such a faucet is operated in circumstances that require frequent on/off operations or a temperature change operation, having a handle that is separated from the location where water is discharged often causes inconvenience, spillage, and limits the utility of the faucet.

Thus, there exists a need for a faucet that provides improved aesthetic appearance, flexible design, and ease of cleaning while also improving the enhanced convenience of control of water flow and temperature that allows for operation by a single hand.

### SUMMARY OF THE INVENTION

The present disclosure provides a faucet for coupling to a pressurized fluid supply that includes a hollow faucet body, a faucet head, a disc valve positioned within the head, and a valve control device. The faucet body has a base at a first end and a second end in fluid communication with the first end. The faucet head has a first end and an outlet at a second end, the first end of the head being removably attached to the second end of the faucet body. The disc valve that is positioned within the faucet head is configured to induce fluid flow and control a temperature of the fluid flow from the pressurized fluid supply through the outlet of the faucet head. The valve control device is positioned on an exterior surface of the faucet head and is mechanically connected to the disc valve and configured to actuate the disc valve.

### BRIEF DESCRIPTION OF THE DRAWINGS

FIG. 1 illustrates a perspective of an inventive mechanical touch faucet;

FIG. 2 illustrates a side view of an inventive mechanical touch faucet;

FIG. 3 is a perspective view of a head of the faucet of FIGS. 1 and 2; and

FIG. 4 is a cross-sectional view of the head of FIG. 3;

FIG. 5 is a magnified view of control lever and disc valve portions of the head of FIG. 3;

FIG. 6 is a magnified view of nozzle and spray selector portions of the head of FIG. 3;

FIGS. 7A and 7B are views of the head of FIG. 3 in the closed and open position, respectively according to a specific embodiment of the invention;

FIG. 8 is a cross-sectional view of the head of FIG. 3 showing the flow;

FIG. 9 is an exploded view of the control lever and disc valve portions of the head;

FIG. 10A is an exploded view of the hoses and quick connect tab separated from the valve assembly according to a specific embodiment of the invention;

FIG. 10B is an assembled view of the components of FIG. 10A;

FIG. 11 is a perspective of an inventive mechanical touch faucet with a replacement faucet head;

FIG. 12A is a cross sectional view of fluid supply hoses arranged in a hose by hose configuration according to embodiments of the present invention;

FIGS. 12B and 12C are cross sectional views of fluid supply hoses arranged in a hose in hose configuration according to embodiments of the present invention;

FIGS. 12D and 12E are a cross sectional views of fluid supply hoses arranged in a two channels in one hose configuration according to embodiments of the present invention;

FIG. 12F is a cross sectional view of the fluid supply hoses of FIG. 12B positioned within a faucet body according to embodiments of the present invention;

FIG. 12G is a cross sectional view of the fluid supply hoses of FIG. 12C positioned within a faucet body according to embodiments of the present invention;

FIG. 13 is a perspective view of a fluid supply hose assembly according to embodiments of the present invention;

FIG. 14 is a disassembled side view of the fluid supply hose assembly of FIG. 13 and a faucet head according to embodiments of the present invention;

FIG. 15 is a cross sectional side view of the fluid supply hose and the faucet head of FIG. 14 being joined together;

FIGS. 16A and 16B show a twin rocker arm valve control device according to embodiments of the present invention;

FIGS. 17A and 17B show a cross rocker valve control device according to embodiments of the present invention;

FIGS. 18A and 18B show a rocker arm and swivel lever valve control device according to embodiments of the present invention;

FIGS. 19A and 19B show a joy stick valve control device according to embodiments of the present invention;

FIG. 20A shows a cross-sectional view of a faucet head having a roller action valve contained therein according to embodiments of the present invention;

FIG. 20B is a perspective view of the faucet head of FIG. 20A;

FIG. 20C is a perspective view of the roller action valve of FIG. 20A;

FIG. 21A shows a cross-sectional view of a faucet head having a slide action valve contained therein according to embodiments of the present invention;

FIG. 21B is a perspective view of the faucet head of FIG. 21A;

FIG. 21C is a perspective view of the slide action valve of FIG. 21A;

FIG. 22A shows a cross-sectional view of a faucet head having a stick action valve contained therein according to embodiments of the present invention;

FIG. 22B is a perspective view of the faucet head of FIG. 22A;

FIG. 22C is a perspective view of the stick action valve of FIG. 22A; and

FIG. 23 illustrates single handed operation of a faucet head according to embodiments of the present invention.

### DESCRIPTION OF THE INVENTION

The present invention has utility as a single hand operation faucet. An inventive faucet affords the benefits of improved aesthetic appearance, flexible design, and ease of cleaning while also improving the convenience of control of water flow and temperature that allows for operation by a single hand.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

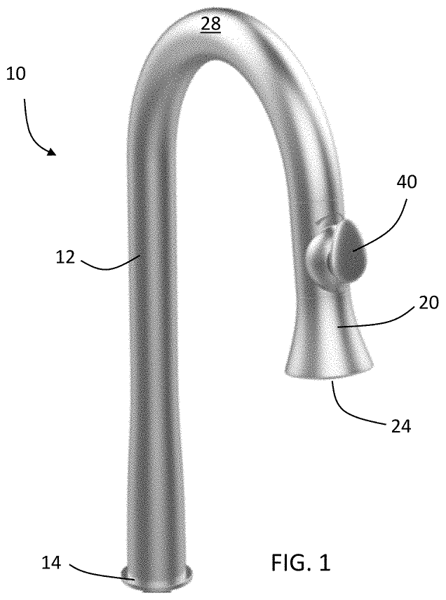

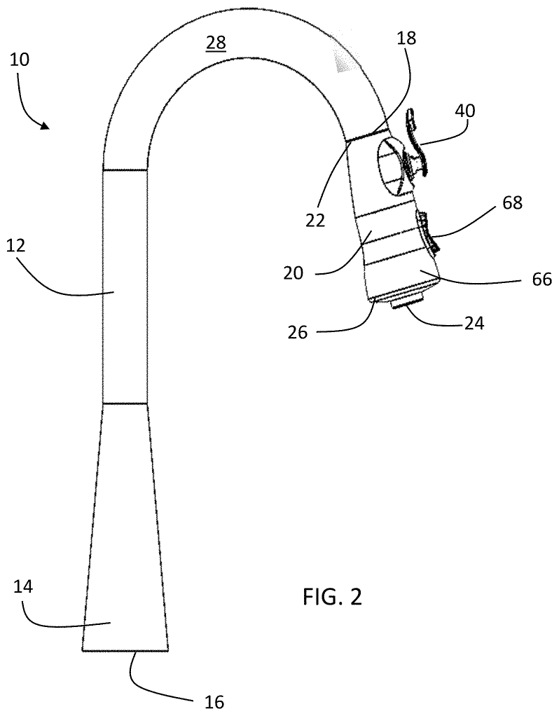

Referring now to the figures, an inventive faucet 10 according to embodiments of the present invention is shown generally in FIGS. 1 and 2. According to embodiments, an inventive faucet 10 includes a faucet body 12 having a base 14 at a first end 16 and a second end 18. It is appreciated that the body 12 need not have a bend relative to the downstream portion as determined relative to a pressurized water supply (not shown) that is in fluid communication with the faucet 10. The faucet body 12 is hollow such that the first end 16 of the body 12 is in fluid communication with the second end 18 of the faucet body 12. The faucet 10 additionally includes a head 20 having a first end 22 and an outlet 24 at a second end 26. According to embodiments, the first end 22 of the head 20 is removably attached to the second end 18 of the faucet body 12. The inventive faucet 10 further includes a disc valve 30 positioned within the head 20, as shown in FIG. 5. The disc valve 30 is configured to induce fluid flow and control a temperature of the fluid flow from the pressurized fluid supply through the outlet 24 of the faucet 10. A control lever 40 positioned on an exterior surface 28 of the water head 20 that is mechanically connected to the disc valve 30, is configured to actuate the disc valve 30 to induce fluid flow and control a temperature of the fluid flow from the pressurized fluid supply through the outlet 24 of the faucet 10.

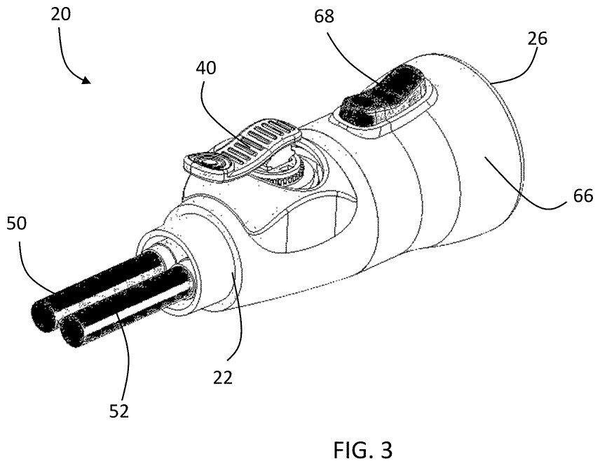

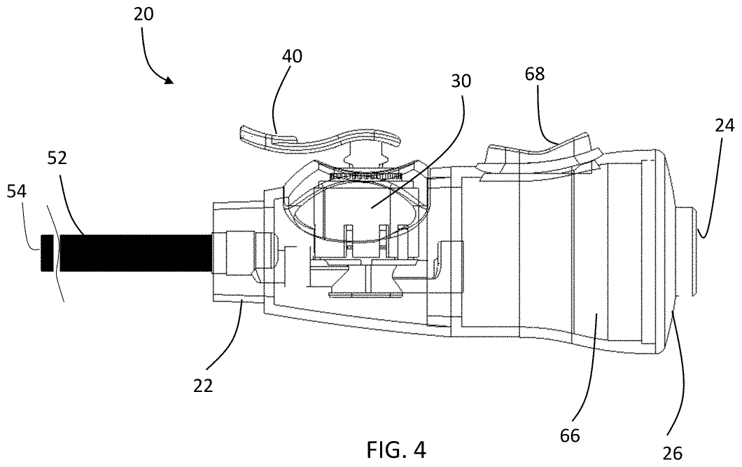

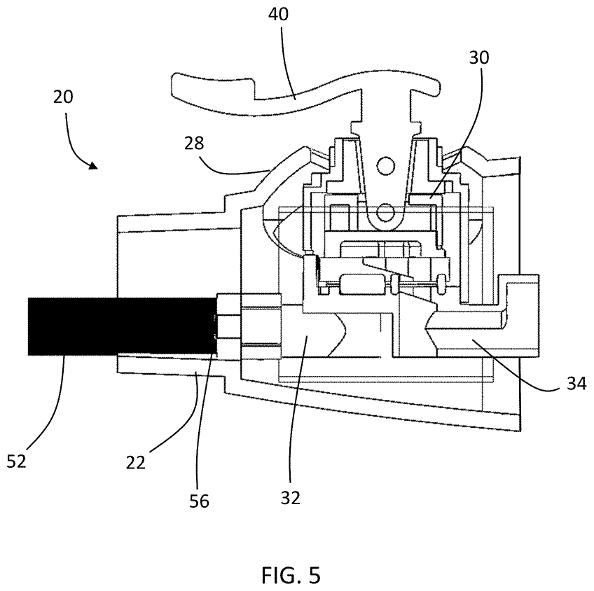

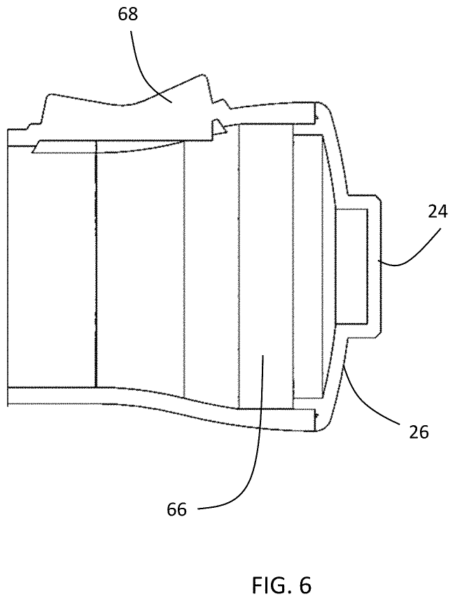

As shown in FIG. 3 in which like reference numerals have the meanings ascribed thereto with regard to the aforementioned drawings, embodiments of the inventive faucet 10 include a first hose 50 and a second hose 52 extending through the hollow faucet body 12 from the first end 16 to the second end 18. Each hose 50, 52 has a first end 54 and a second end 56. The first end 54 of the hoses 50, 52 are configured to be coupled to the pressurized fluid supply via a connector 55, while each of the second ends 56 are configured to be coupled to an inlet 32 of the disc valve 30 within the head 20 of the faucet 10. It will be understood that the length of the hoses 50, 52 can vary but that the general length of the hoses 50, 52 is such that each of the first ends 54 can be coupled to the pressurized fluid supply, which may be located a relatively long distance from the base 12 of the faucet 10. Additionally, the hoses 50, 52 include extra length to allow to the head 20 to be sufficiently extended from the base 12 of the faucet 10. According to embodiments, the first hose 50 is a hot fluid supply and the second hose 52 is a cold fluid supply. According to embodiments, the hoses 50, 52 are high pressure capable hoses. Notably, this feature is unlike existing faucets with mixing valves that are positioned near the base of the faucet, far from the outlet of the faucet. In traditional faucets with valves mounted on the body of the faucet near the base of the faucet, the hot and cold water hoses enter the mixing valve by a first hose and a second hose, which are high pressure capable hoses. Fluid supplied by these hoses is mixed at the mixing valve near the base of the faucet This mixed fluid is conducted from the mixing valve near the base of the faucet to the outlet of the faucet through a third hose, which is typically not high pressure capable, given that water downstream of such existing mixing valves is at low pressure. This third hose snakes from the base of the faucet into the kitchen cabinet and up again to the water outlet tip at the far end of the faucet. In contrast, the first hose 50 and second hose 52 of the present invention supply fluid from the pressurized fluid supply to the inlet 32 of the disc valve 30, where the fluid is mixed and then directly flows to the outlet 24 of the head 20, thereby eliminating the need for a third hose, the snaking of such a hose back through the kitchen cabinet, and the many direction changes required of the flowing water. By eliminating this third hose and the many changes in water direction the faucet configuration of the present invention provides less loss of temperature of the flowing fluid and less loss of pressure, thus resulting in better energy efficiency.

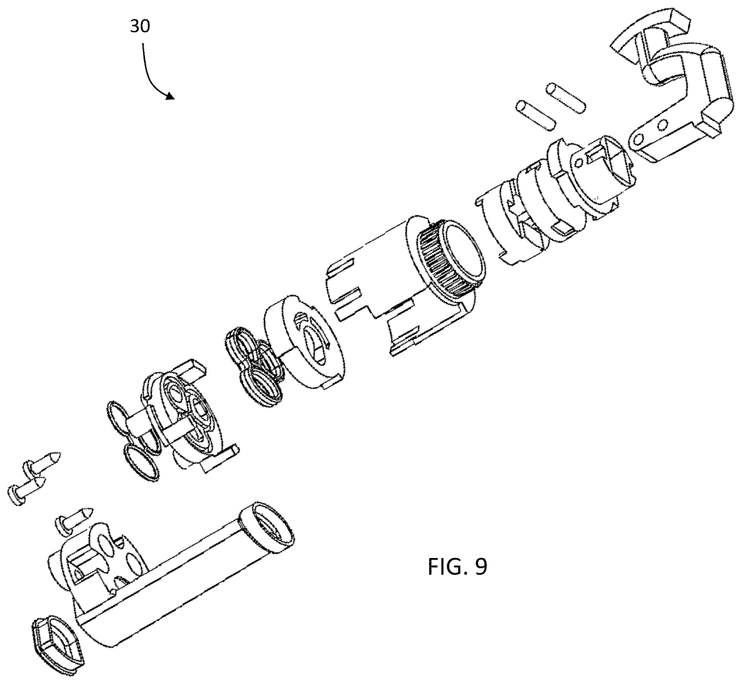

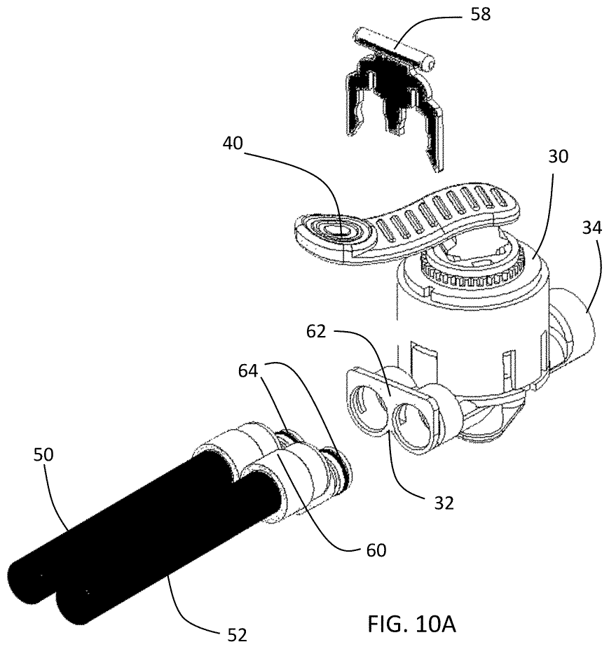

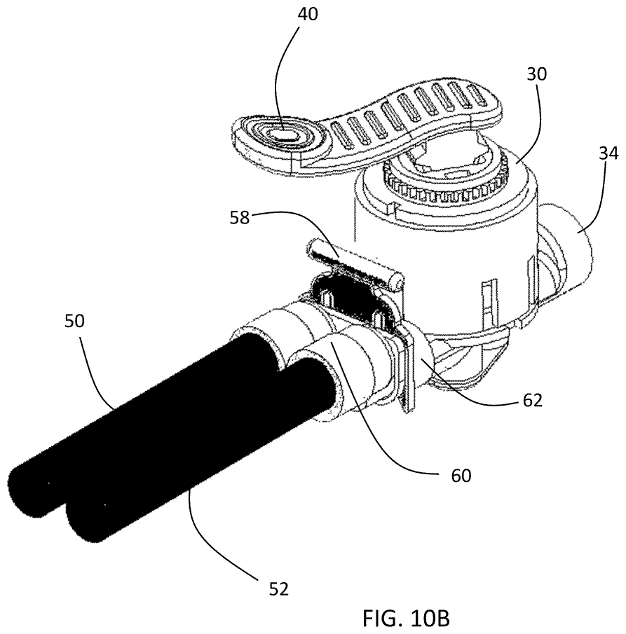

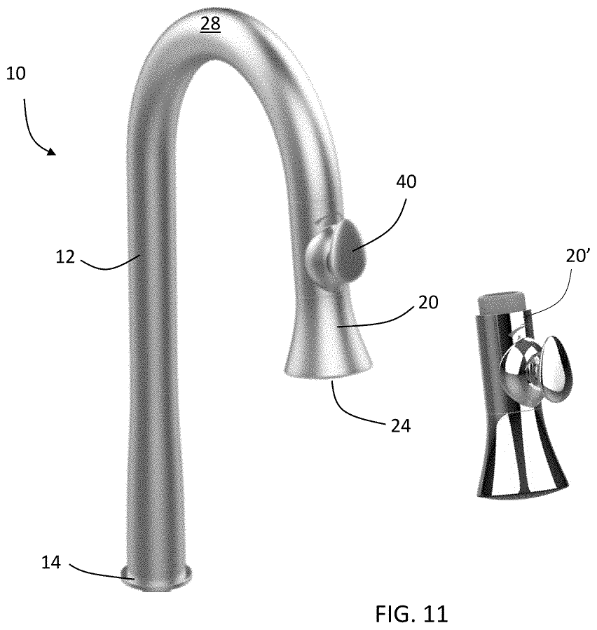

As shown in FIGS. 10A and 10B3 in which like reference numerals have the meanings ascribed thereto with regard to the aforementioned drawings, the second ends 56 of the hoses 50, 52 are coupled to the inlet 32 of the disc valve 30 by a quick connect tab 58. In such embodiments, the faucet 10 may further include an end fitting 60 that is fixed to the second ends 56 of the hoses 50, 52 that is configured to engage with a corresponding inlet fitting 62 at the inlet 32 of the disc valve 30. According to embodiments, the end fitting 60 is friction fit into the corresponding inlet fitting 62. Additionally, the end fitting 60 may include a gasket 64 for each hose 50, 52 to prevent leaks. According to embodiments, the quick connect tab 58 slides over the inlet fitting 62 once the end fitting 60 is positioned therein to retain the end fitting 60 within the inlet fitting 60. Thus, the quick connect tab 58 provides for fast and easy assembly and replacement of the faucet 10 components. For example, as shown in FIG. 11, the inventive faucet with the mixing valve 30 located within the head 20 of the faucet and with the water supply hoses 50, 52 being easily connected and disconnected from the valve 30 via a quick connect tab 58 or similar easily to install connector, may include a replacement faucet head 20′ that is simple and easy to replace without the need for a professional or special technical expertise. Such a replacement head 20′ allows the entire mixing valve 30 to be replaced easily in the event that any component thereof fails. In contrast, traditional faucets with the mixing valve located near the base of the faucet require professional and technical expertise to repair or replace the mixing valve or replacement of the entire faucet, which is expensive and wasteful.

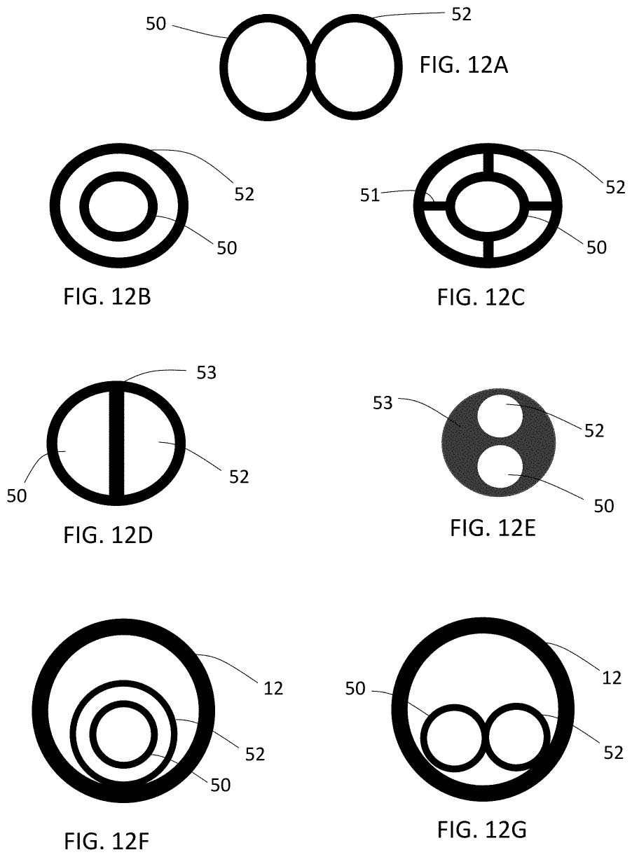

As noted above, the supply hoses 50, 52 are, according to embodiments, two separate hoses that are external to one another and that are held together by the end fitting 60, which is insertable into a corresponding inlet fitting 62 at the inlet 32 of the disc valve 30. It will be understood that the supply hoses can be arranged in a number of configurations according to various embodiments, For example, FIGS. 12A-12G show cross-sectional views of several non-exhaustive configurations of the supply hoses 50, 52. That is FIG. 12A shows the supply hoses 50, 52 as two separate hoses that are external to one another. FIGS. 12B and 12C show the supply hoses 50, 52 as a hose within a hose, with the embodiment of FIG. 12C including internal walls 51 that maintain the spacing of the two hoses. FIGS. 12D and 12E show the supply hoses 50, 52 as two channels within a single tube 53. It will be understood that the hose within a hose configuration or the two channels within a single hose configuration provide for a smaller fluid supply assembly than is afforded with a hose by hose configuration. Additionally, the hose within a hose configuration or the two channels within a single hose configuration are advantageous in that these configurations provide a smaller area of friction when drawing the hoses 50, 52 through the faucet body 12, as shown in FIG. 12F, making pulling the faucet head 20 away from the faucet body 12 easier for a user. In comparison the hose by hose configuration is shown in FIG. 12G, which has multiple friction points and is thus harder to pull for the user.

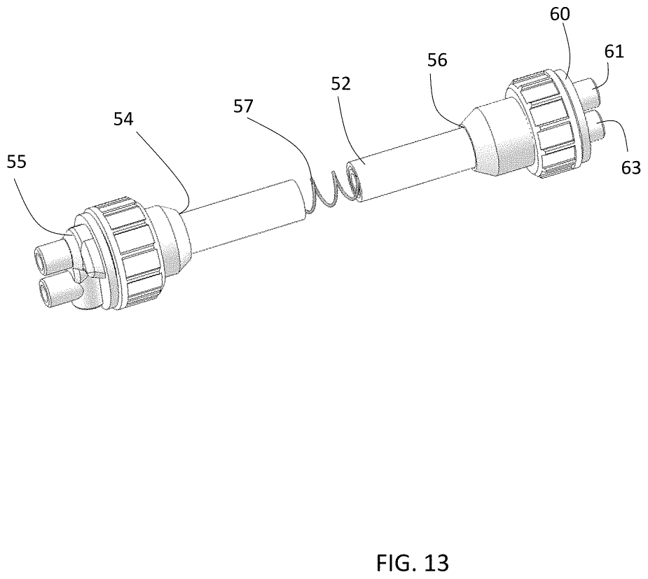

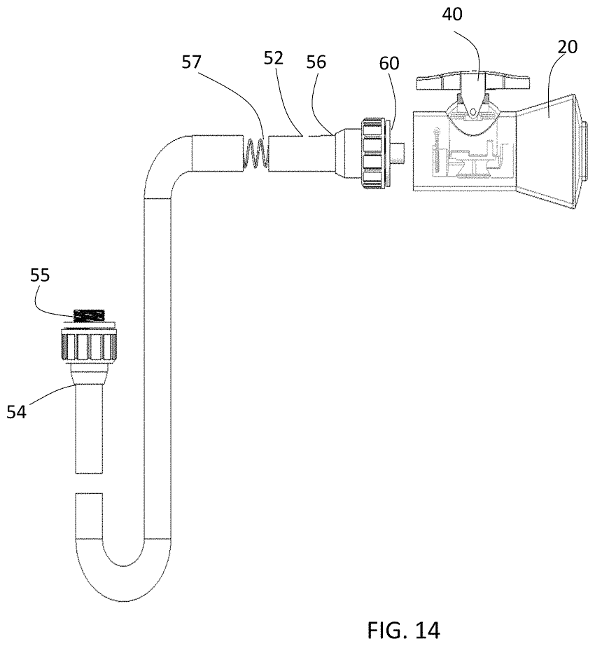

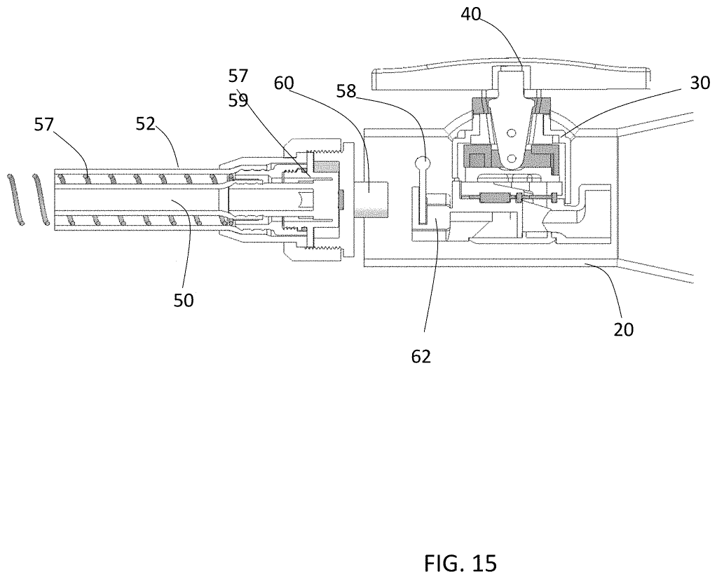

As shown in FIGS. 13-15, embodiments of the present invention provide the fluid supply hoses 50, 52 as a hose in hose configuration with a hose end fitting 60 that is fixed to the second ends 56 of the hoses 50, 52 that is configured to engage with a corresponding inlet fitting 62 at the inlet 32 of the disc valve 30. Additionally, the first end 54 of the hoses 50, 52 are configured to be coupled to the pressurized fluid supply via a connector 55. FIG. 13 shows a perspective view of the supply hoses 50, 52 with the fluid supply connector 55 provided at the first end 54 and the end fitting 60 provided at the second end 56. FIG. 14 shows a side view of the supply hoses 50, 52 with the fluid supply connector 55 provided at the first end 54 and the end fitting 60 provided at the second end 56, with the end fitting 60 ready to be attached to the a corresponding inlet fitting 62 at the inlet 32 of the disc valve 30 within the head 20 of the faucet. FIG. 15 shows a cross-sectional view of the supply hoses 50, 52 with the end fitting 60 provided at the second end 56, with the end fitting 60 ready to be attached to the a corresponding inlet fitting 62 at the inlet 32 of the disc valve 30 within the head 20 of the faucet. As shown, the quick connect tab 58 is still positioned in the inlet fitting 62. It will be understood that the quick connect tab 58 would need to be removed from the inlet fitting 62 for the end fitting 60′ to be attached to the inlet fitting 62, at which point the quick connect tab 58 would then be replaced to secure the end fitting 60′ to be attached to the inlet fitting 62. As shown in FIG. 15, the supply hoses 50, 52 are arranged in a hose in hose configuration, with a spring 57 provided within the outer hose 50, and outside of the inner hose 52. The spring 57 act to maintain the spacing between the two hoses 50, 52 and assists with bringing the hoses 50, 52 back to a position within the faucet body 12 after the faucet head 20 and hoses connected thereto has been pulled away from the faucet body 12 during use. Furthermore, an adapter 59 is provided at the second ends 56 of the hoses 50, 52 so that the fluid flowing within the concentric hoses 50, 52 are routed to the two outlets 61, 63 provided in the end fitting 60. Such an adapter may also be provided at the first end 54 of the hoses 50, 52 so that the two fluid supplies are routed into the two concentric hoses 50, 52.

According to embodiments, the faucet 10 includes a nozzle 66 at the outlet 24 of the head 20. The nozzle 66 is configured to control the pressure, flow rate, and/or spray pattern of the fluid as it flows through the outlet 24 of the head 20 of the faucet 10. Furthermore, the faucet additionally may include an aeration and spray selector 68 positioned on the exterior surface 28 of the head 20, such that the selector 68 may be actuated by a single hand of a user during operation of the faucet 10 to select or change the pressure, flow rate, and/or spray pattern of the fluid as it flows through the outlet 24 of the head 20 of the faucet 10.

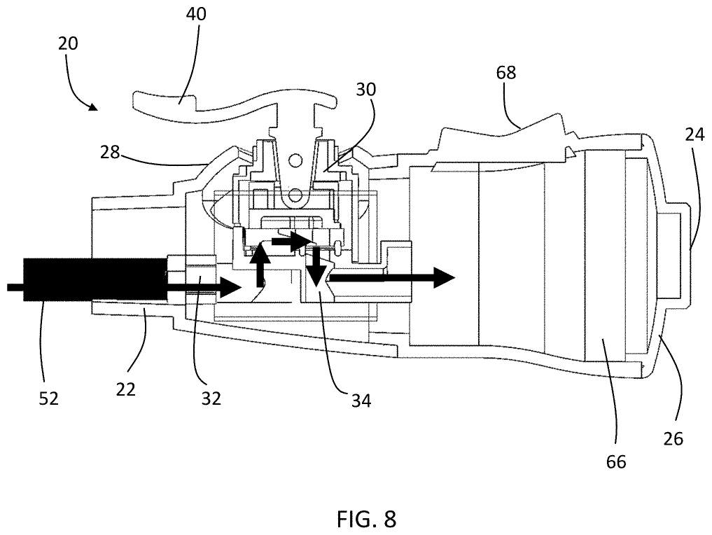

As shown in FIG. 9 in which like reference numerals have the meanings ascribed thereto with regard to the aforementioned drawings, the disc valve 30 includes several components. According to embodiments, the disc valve 30 is a ceramic disc valve. The disc valve 30 has an inlet 32 and an outlet 34. As best shown in FIG. 8 in which like reference numerals have the meanings ascribed thereto with regard to the aforementioned drawings, the disc valve 30 in the head 20 is configured to receive fluid flow from the pressurized fluid supply via the hoses 50, 52, mix the fluid flowing from the first hose 50 and the second hose 52 to regulate the temperature of the fluid as it flows to the outlet 34 of the disc valve 30 and through to the outlet 24 of the head 20. As shown in FIG. 8, the configuration of the disc valve 30 of the present invention provides a generally linear flow path for the fluid through the head 20 and the disc valve 30. Accordingly, the disc valve 30 of the present invention provides for fewer direction changes in the fluid flow path as compared to existing mixing valves. The fewer direction changes in the fluid flow path reduces temperature and pressure loss of the faucet 10, thus enhancing the energy and efficiency of the inventive faucet.

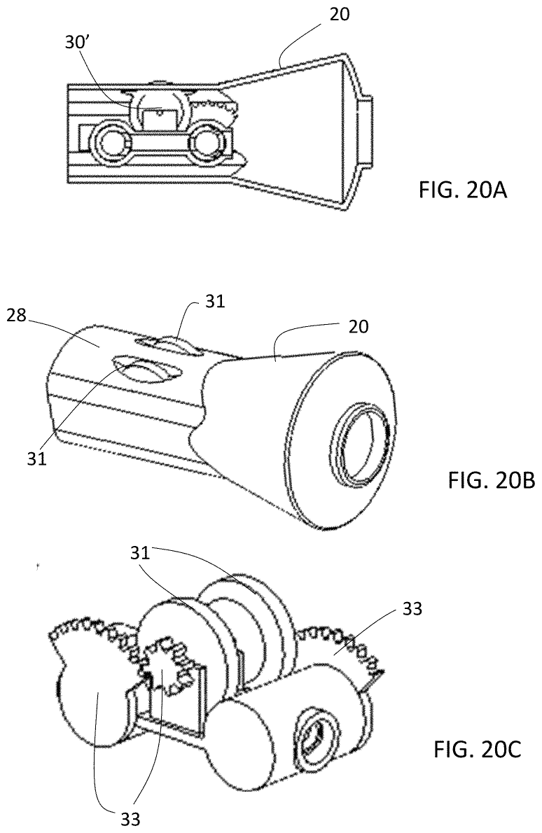

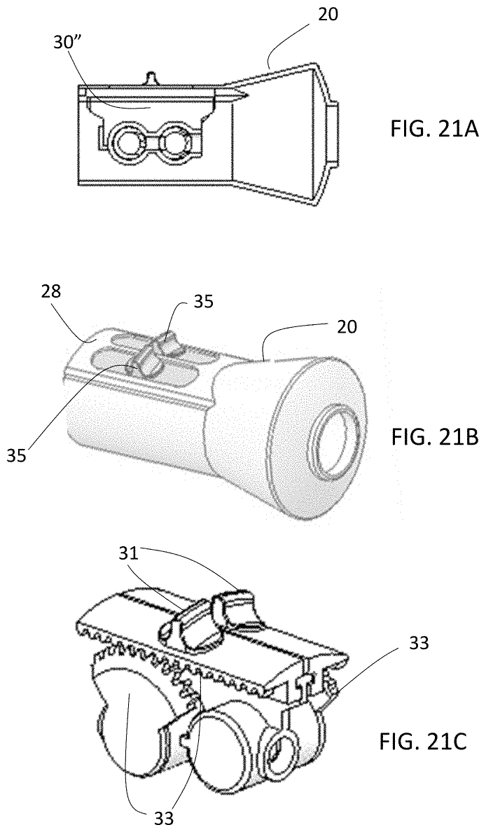

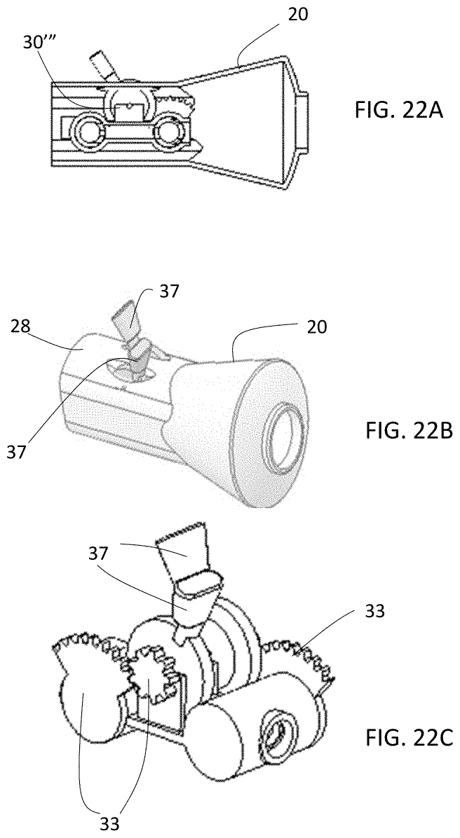

According to embodiments, the mixing valve provided in the head 20 of the faucet is a roller controlled valve 30′ as shown in FIGS. 20A-20C in which rollers 31 accessible at the surface 28 of the faucet are connected to gears 33 internal to the head 20. Operation of the rollers 31 control the opening and closing of the valve 30′ via the gears 33 to induce fluid flow from the inlet 32 to the outlet 34 of the valve 30′. Similarly, as shown in FIGS. 21A-21C, the mixing valve provided in the head 20 of the faucet is a slide action controlled valve 30″ that includes slides 35 accessible at the surface 28 of the faucet are connected to gears 33 internal to the head 20. Operation of the slides 35 control the opening and closing of the valve 30″ via the gears 33 to induce fluid flow from the inlet 32 to the outlet 34 of the valve 30″. Further, as shown in FIGS. 22A-22C, the mixing valve provided in the head 20 of the faucet is a slide action controlled valve 30″′ that includes sticks 37 accessible at the surface 28 of the faucet are connected to gears 33 internal to the head 20. Operation of the sticks 37 control the opening and closing of the valve 30″′ via the gears 33 to induce fluid flow from the inlet 32 to the outlet 34 of the valve 30″′.

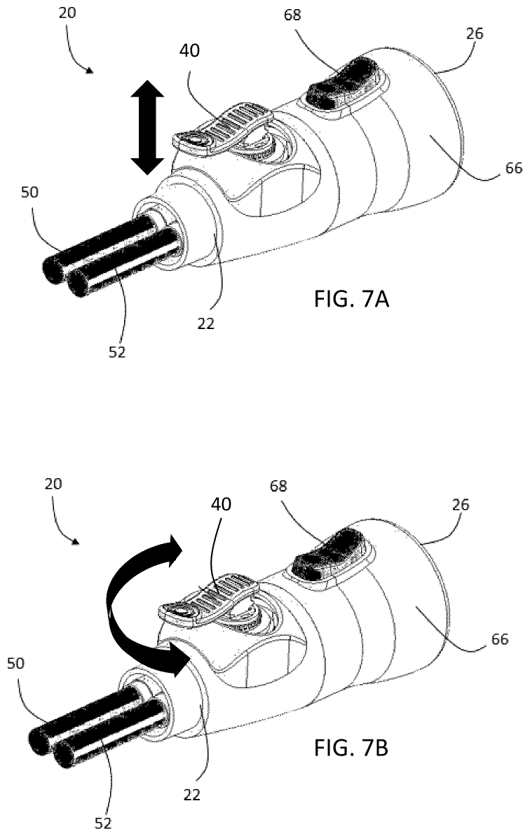

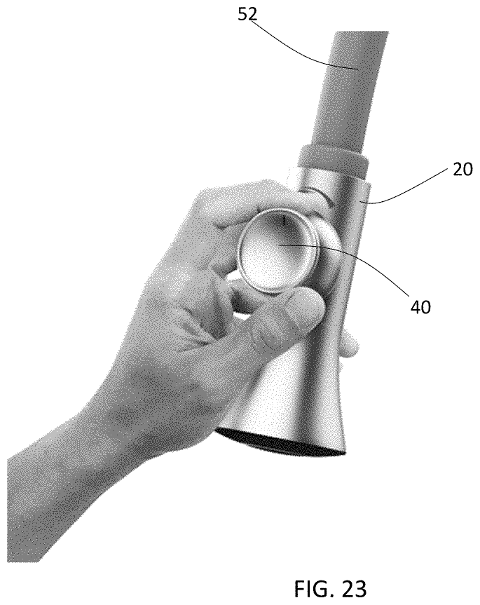

As shown in FIG. 7A in which like reference numerals have the meanings ascribed thereto with regard to the aforementioned drawings, the disc valve 30 and the control lever 40 are mechanically connected such that depressing the control lever 40 actuates the disc valve 30 to include fluid flow from the pressurized fluid supply such that the fluid may flow through the head 20 and disc valve 30 to the outlet 24 of the head such that the faucet 10 is in an on configuration. Accordingly, when the control lever 40 is not actuated, fluid flow from the pressurized fluid supply is prevented by the disc valve 30 such that the faucet 10 is in an off configuration. Furthermore, as shown in FIG. 7B in which like reference numerals have the meanings ascribed thereto with regard to the aforementioned drawings, the disc valve 30 and the control lever 40 are mechanically connected such that rotation of the control lever 40 actuates the disc valve 30 to adjust the temperature of the fluid flow from the pressurized fluid supply via the mixing operation of the disc valve 30. Advantageously, the control lever 40 and its mechanical connection to the disc valve 30 allows for both lateral and rotational activation by a single finger of a user. Thus, the inventive faucet 10 provides for enhanced ease of use and convenience of control of water flow and temperature adjustment with a single hand, as shown in FIG. 23.

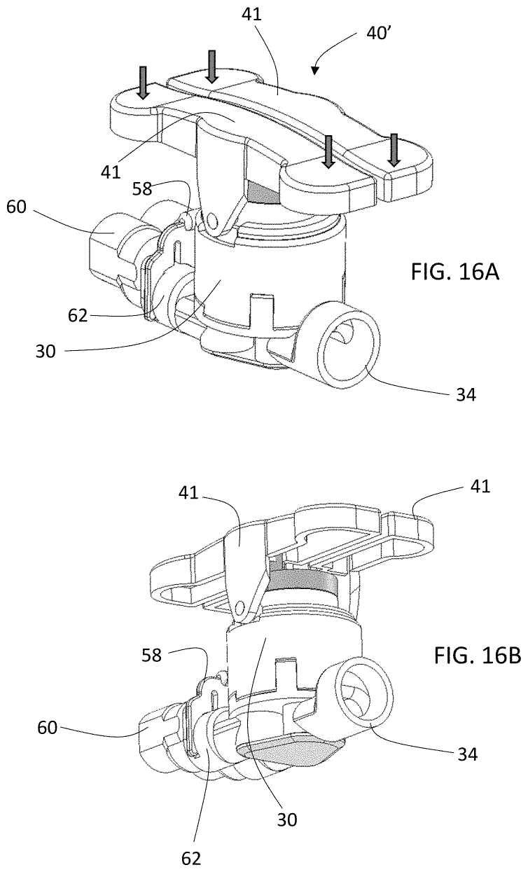

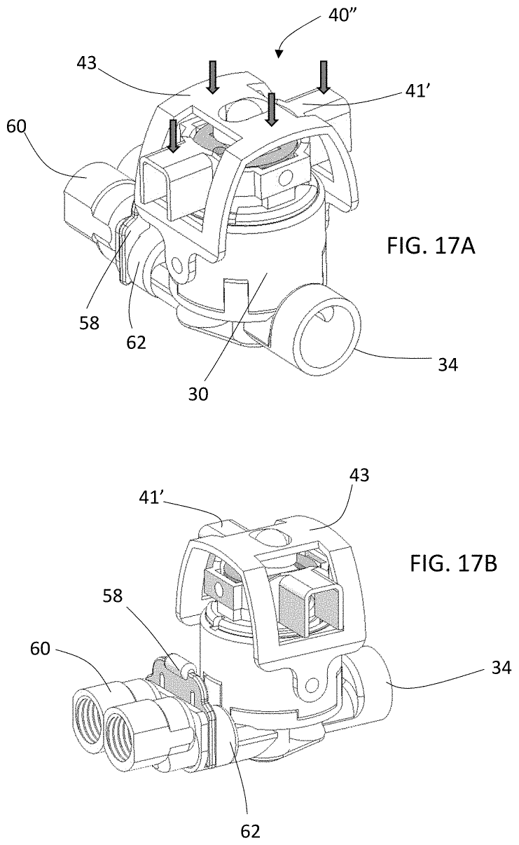

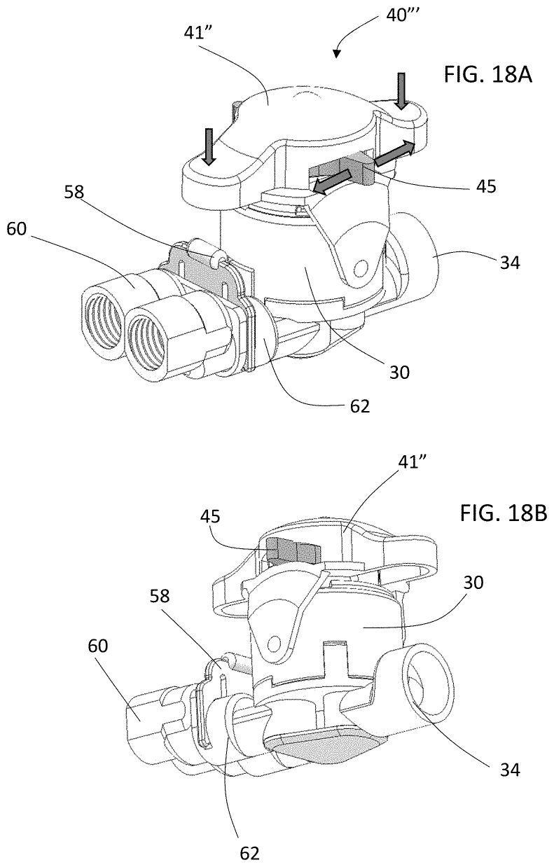

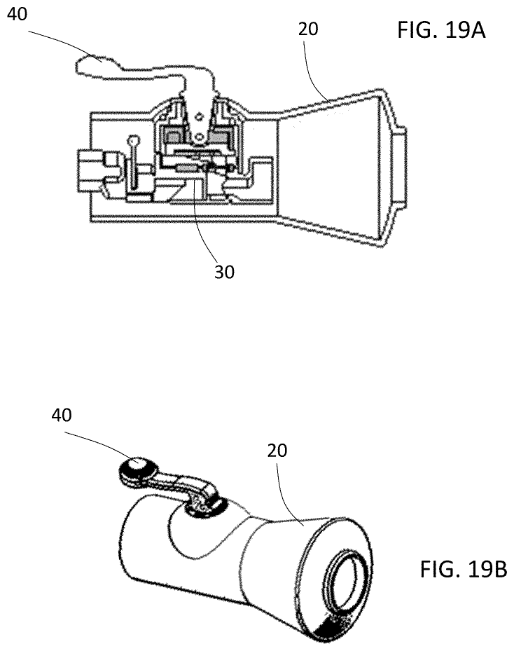

As shown in FIGS. 16A-19B, which like reference numerals have the meanings ascribed thereto with regard to the aforementioned drawings, the control lever 40, by which the disc valve 30 is controlled and operated to induce fluid flow from the pressurized fluid supply, is provided as a number of several non-exhaustive alternatives. That is, as shown in FIGS. 16A and 16B, the control lever 40′ includes twin rocker arms 41 that when pressed down in various combinations as indicated by the arrows induce fluid flow through the valve 30 from the fluid supply hoses 50, 52 alone or in combination. As shown in FIGS. 17A and 17B, the control lever 40″ includes a cross rocker configuration with a rocker arm 41′ and a rocker cap 43. Furthermore, as shown in FIGS. 18A and 18B, the control lever 40″′ includes a rocker arm 41″ and a swivel arm 45, with the rocker arm 41″ for example inducing the flow or water and the swivel arm 45 controlling the temperature. As shown in FIGS. 19A and 19B, the control lever 40 includes a joystick arm as shown in FIGS. 7A and 7B that is configured to be pushed up and down and swiveled side to side.

Unless noted to the contrary, components of the inventive faucet 10 are formed of materials conventional to the art of plumbing fixture manufacture and in recognition that material compatibility is required for a given fluid flowing therethrough.

While the present invention is detailed herein with respect to the mechanically controlled flow of water, it is appreciated that an inventive faucet 10 is suitable for delivery of aqueous solutions that illustratively include carbonated beverages, alcoholic drinks, medicaments, and juices; organic liquids; and other compositions flowable at temperatures compatible with the inventive faucet construction. As used herein, the term “water” should be treated as being synonymous with a generic liquid fluid.

The faucet 10 may have an exterior surface 28 that is made of chrome plated materials, stainless steel, metals, plastics, composite materials, and combinations thereof.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A faucet for coupling to a pressurized fluid supply, the faucet comprising:
a faucet body having a base at a first end, the faucet body being hollow such that the first end is in fluid communication with a second end of the faucet body;
a head having a first end and an outlet at a second end, the first end of the head being removably attached to the second end of the faucet body;
a disc valve positioned within the head, the disc valve configured to induce fluid flow and control a temperature of the fluid flow from the pressurized fluid supply through the outlet of the head; and
a valve control device positioned on an exterior surface of the water head, the valve control device being mechanically connected to the disc valve and configured to actuate the disc valve.

2. The faucet of claim 1 further comprising a first hose and a second hose extending through the faucet body, each hose having a first end and a second end, the first ends configured to receive fluid from the pressurized fluid supply and the second ends configured to deliver fluid from the pressurized fluid supply to an inlet of the disc valve.

3. The faucet of claim 2 wherein the first hose and the second hose are high pressure capable.

4. The faucet of claim 2 further comprising an end fitting configured to couple the second ends of the hoses to the inlet of the disc valve.

5. The faucet of claim 4 further comprising a quick connector tab that releasably secures the end fitting to the inlet of the disc valve.

6. The faucet of claim 2 further comprising a connector that connects the first ends of the hoses to the pressurized fluid supply.

7. The faucet of claim 2 wherein the first hose is a hot fluid supply and the second hose is a cold fluid supply.

8. The faucet of claim 2 wherein the first hose is disposed within the second hose.

9. The faucet of claim 8 further comprising a coil spring disposed about an outside surface of the first hose and disposed internal to the second hose.

10. The faucet of claim 2 wherein the first hose is a first channel within a tube and the second hose is a second channel within the tube.

11. The faucet of claim 1 wherein the valve control device is configured to be actuated by a single finger of a user.

12. The faucet of claim 1 wherein the valve control device is a control lever configured to be depressed to actuate the disc valve to include fluid flow from the pressurized fluid supply through the outlet of the head.

13. The faucet of claim 12 wherein rotation of the control lever actuates the disc valve to adjust the temperature of the fluid flow from the pressurized fluid supply through the outlet of the head.

14. The faucet of claim 1 wherein the valve control device includes a first rocker arm and a second rocker arm, wherein the first rocker arm is configured to be depressed at ends thereof to actuate the disc valve to include fluid flow from the pressurized fluid supply through the outlet of the head and wherein the second rocker arm is configured to be depressed at ends thereof to adjust the temperature of the fluid flow from the pressurized fluid supply through the outlet of the head.

15. The faucet of claim 1 wherein the valve control device includes a rocker arm and a swivel lever, wherein the rocker arm is configured to be depressed at ends thereof to actuate the disc valve to include fluid flow from the pressurized fluid supply through the outlet of the head and wherein the swivel lever is configured to be pivotably adjusted to adjust the temperature of the fluid flow from the pressurized fluid supply through the outlet of the head.

16. The faucet of claim 1 further comprising a nozzle at the outlet of the head.

17. The faucet of claim 1 further comprising an aeration and spray selector positioned on the exterior surface of the head.

18. The faucet of claim 1 wherein the disc valve is a ceramic disc valve.

19. The faucet of claim 1 wherein the disc valve is a geared disc valve.

20. The faucet of claim 17 wherein the geared disc valve and wherein the valve control device that is mechanically connected to the geared disc valve and configured to actuate the geared disc valve is any of a pair of rollers, a pair of slides, or a pair of sticks.
